(19) United States
(12) Patent Application Publication
(10) Pub. No.: US 2018/0171161 A1
(43) Pub. Date: Jun. 21, 2018

(54) CONDUCTIVE COATING COMPOSITION, CONDUCTIVE MATERIAL, METHOD FOR MANUFACTURING CONDUCTIVE COATING COMPOSITION, AND METHOD FOR MANUFACTURING CONDUCTIVE MATERIAL

(71) Applicant: PANASONIC INTELLECTUAL PROPERTY MANAGEMENT CO., LTD., Osaka (JP)

(72) Inventor: Akihiko TADAMASA, Osaka (JP)

(21) Appl. No.: 15/739,686

(22) PCT Filed: Jun. 24, 2016
(86) PCT No.: PCT/JP2016/003049

§ 371 Date: Dec. 22, 2017

(30) Foreign Application Priority Data
Aug. 24, 2015 (JP) 2015-165188
Mar. 7, 2016 (JP) 2016-043856

(51) Int. Cl. C09D 5/24; C09D 7/40; C09D 167/00; C09D 133/04; C09D 163/00; C09D 179/08; C09D 101/02; H01B 1/22; H01B 1/24

(52) U.S. Cl. CPC C09D 5/24; C09D 7/69; C09D 167/00; C09D 133/04; C08K 3/042; C09D 179/08; C09D 101/02; H01B 1/22; H01B 1/24; C09D 163/00

(57) ABSTRACT

A conductive coating composition includes graphite intercalation compounds, metal particles, a binder, and a dissolving agent. The graphite intercalation compounds are compounds having a sandwich structure where various atoms, molecules, etc., are inserted between layers of graphite, which is a layered material in which carbon hexagonal net planes are laminated in parallel. The binder and the dissolving agent allow the graphite intercalation compounds and the metal particles to be bonded. The volume of the graphite intercalation compounds in the conductive coating composition is larger than the volume of the metal particles in the conductive coating composition.

### TECHNICAL FIELD

The present invention relates to a conductive composite material and particularly to a conductive coating composition, a conductive material, a method for manufacturing the conductive coating composition, and a method for manufacturing the conductive material, in which graphite intercalation compounds are used.

BACKGROUND ART

With the development of electronics technology, circuits formed by printing a conductive coating have started to be used for signal circuits in printed wiring circuits, etc. Conductive materials used for such a purpose are required to be lightweight and highly conductive. For this reason, graphite intercalation compounds are dispersed in a synthetic resin matrix (for example, see Patent document No. 1).

[Patent document No. 1] JPH5-65366

### DISCLOSURE OF THE INVENTION

### Problem to be Solved by the Invention

One of materials that realize high conductivity is a metal material such as silver. However, the unit price of a metal material is generally high. Therefore, a further improvement in the conductivity is required while using graphite intercalation compounds whose unit price is relatively low.

In this background, a purpose of the present invention is to provide a technology for improving conductivity while preventing an increase in unit price.

### Means to Solve the Problem

A conductive coating composition according to one embodiment of the present invention includes graphite intercalation compounds, metal particles, a binder, and a dissolving agent, and the volume of the graphite intercalation compounds in the conductive coating composition is larger than the volume of the metal particles in the conductive coating composition.

Another embodiment of the present invention relates to a conductive material. The conductive material includes graphite intercalation compounds and metal particles, and the volume of the graphite intercalation compounds in the conductive material is larger than the volume of the metal particles in the conductive material.

Yet another embodiment of the present invention relates to a method for manufacturing a conductive coating composition. This is a method for manufacturing the conductive coating composition, including: producing a conductive material by mixing graphite intercalation compounds and metal particles; producing a binder solution while agitating and heating a binder and a dissolving agent; and adding the conductive material in the binder solution, wherein the volume of the graphite intercalation compounds in the conductive coating composition is larger than the volume of the metal particles in the conductive coating composition.

Yet another embodiment of the present invention relates to a method for manufacturing a conductive material. This is a method for manufacturing a conductive material in which graphite intercalation compounds and metal particles are mixed, and the volume of the graphite intercalation compounds in the conductive material is larger than the volume of the metal particles in the conductive material.

### Advantageous Effects

According to the present invention, conductivity can be improved while preventing an increase in unit price.

### BRIEF DESCRIPTION OF THE DRAWINGS

FIG. 1 is a diagram illustrating the configuration of a conductive coating composition according to an embodiment of the present invention.

### MODE FOR CARRYING OUT THE INVENTION

A brief description of the present invention will be given first before a specific description thereof is given. An embodiment of the present invention relates to a conductive material containing a graphite intercalation compound and to a conductive coating composition for which the conductive material is used. As described above, although a metal material has high conductivity, the unit price of the metal material is high. On the other hand, although the unit price of a carbon material is low, the carbon material has low conductivity. Meanwhile, a graphite intercalation compound has relatively high conductivity while being inexpensive. Therefore, an improvement in the conductivity of a graphite intercalation compound is required. In the present embodiment, a metal particle is bonded to a graphite intercalation compound. This is because, in a graphite intercalation compound, the conductivity is increased when bonded to a metal particle since an acceptor level is formed in the graphite and the carrier density becomes high when the acceptor level is formed. This allows for graphite based paste to be realized that is inexpensive and yet has high conductivity.

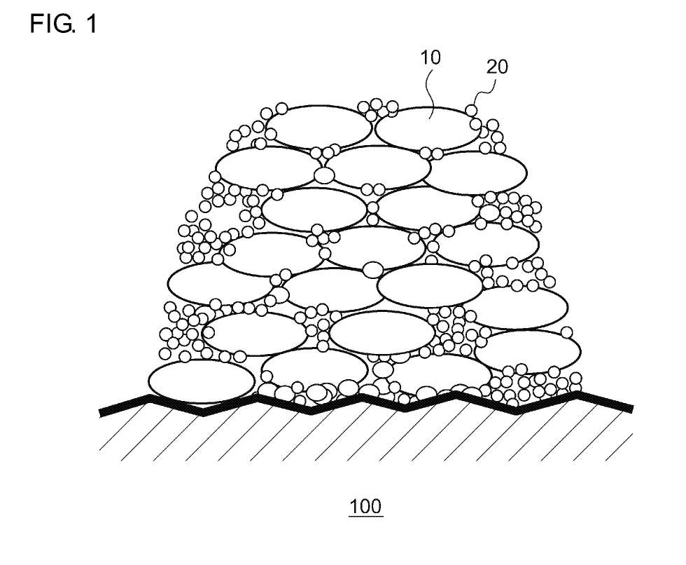

FIG. 1 illustrates the configuration of a conductive coating composition 100 according to the embodiment of the present invention. The conductive coating composition 100 includes graphite intercalation compounds 10 and metal particles 20. Further, the conductive coating composition 100 includes a binder and a dissolving agent (not shown) in order for these to be bonded. The graphite intercalation compounds 10 and the metal particles 20 are also considered to be conductive materials.

The graphite intercalation compounds 10 are compounds having a sandwich structure where various atoms, molecules, etc., are inserted between layers of graphite, which is a layered material in which carbon hexagonal net planes are laminated in parallel. In the graphite intercalation compounds 10, due to intercalates such as atoms, molecules, etc., that have inserted between layers of graphite and charge transfer occurring between the intercalates and adjacent layers of graphite, the number of conduction carriers on the layers of graphite becomes increased. As a result, the graphite intercalation compounds 10 have high conductivity.

For the graphite intercalation compounds 10, for example, powder of scaly natural graphite, artificial graphite, vapor-grown carbon fibers, graphite fibers, or the like are used as a base material. For the graphite intercalation compounds 10, a pyrolytic graphite sheet obtained by treating a polyimide film with heat at a temperature of 2600 to 3000 degrees Celsius or a pyrolytic graphite sheet that has been ground may also be used as the base material. Further, for the graphite intercalation compounds 10, graphite materials with good crystal integrity such as those carrying a metal at an end portion of these graphite materials may be used as base materials. In order for a metal to be carried at an end portion of a graphite material, for example, a metal complex and a graphite material are mixed and then burned. The base material is not limited to these materials.

As the intercalates, all sorts of substance species such as atoms, molecules, ions, etc., can be used, and, for example, metal chlorides, alkali metals, and alkaline earth metals are used. Examples of the metal chlorides include iron chlorides, copper chlorides, nickel chlorides, aluminum chlorides, zinc chlorides, cobalt chlorides, gold chlorides, bismuth chlorides, etc., and examples of the alkali metals and the alkaline earth metals include lithium, potassium, rubidium, cesium, calcium, magnesium, etc. As the intercalates, two or more of these substances may be used in combination. Furthermore, graphite intercalation compounds 10 in which metal chlorides have been inserted may be treated with heat under a stream of hydrogen of 5 to 100 percent and at a temperature of 250 to 500 degrees Celsius, thereby reducing the metal chlorides that have been inserted so that the metal chlorides are present as metal microparticles. When the intercalates inserted inside graphite are iron chlorides or copper chlorides that have a high electron affinity, the intercalates function as acceptors that introduce holes to the graphite intercalation compounds 10. Also, when the intercalates inserted inside graphite are lithium, potassium, or cesium whose ionization potential is smaller than that of the graphite, the intercalates function as donors that donate electrons to the graphite intercalation compounds 10.

For the metal particles 20, metal powder is used. Examples of the metal powder include stainless steel, titanium oxide, ruthenium oxide, indium oxide, aluminum, iron, copper, gold, silver, platinum, titanium, nickel, magnesium, palladium, chromium, tin, tantalum, niobium, etc. Further, the metal particles 20 may be metal silicide based conductive ceramics, metal carbide based conductive ceramics, metal arsenide based conductive ceramics, or metal nitride based conductive ceramics. Examples of the metal silicide based conductive ceramics include iron silicide, molybdenum silicide, zirconium silicide, titanium silicide, etc. Examples of the metal carbide based conductive ceramics include tungsten carbide, silicon carbide, calcium carbide, zirconium carbide, tantalum carbide, titanium carbide, niobium carbide, molybdenum carbide, vanadium carbide, etc. Examples of the metal arsenide based conductive ceramics include tungsten boride, titanium boride, tantalum boride, zirconium boride, etc. Examples of the metal nitride based conductive ceramics include chromium nitride, aluminum nitride, molybdenum nitride, zirconium nitride, tantalum nitride, titanium nitride, gallium nitride, niobium nitride, vanadium nitride, boron nitride, etc. Also, the metal particles 20 may be synthesized powder in which two or more of these metal powders are used. Further, the form of the metal particles 20 is fiber, where a metal is deposited on inorganic or organic fibers or inorganic or organic fibers are plated with metal, or powder.

For the binder, a polyester resin, a vinyl resin, a phenol resin, an acrylic resin, an epoxy resin, a polyimide based resin, cellulose, etc. are used. The binder is not limited to these materials.

The dissolving agent is also referred to as solvent. As the solvent, 50 percent by mass or higher of a solvent having a boiling point of 150 degrees Celsius or higher, particularly, a solvent having a boiling point of 200 degrees Celsius or higher is preferably included. As described, by including a lot of solvent having a high boiling point, the dispersibility of carbons and inorganic substances can be easily ensured, and a smooth film can be obtained. Also, as the solvent, a solvent that has a high affinity for inorganic substances (metals, etc.) and that dissolves an additive that is described later is preferably used, and, in general, an organic solvent that has an alcoholic OH group is preferably used.

Examples of the organic solvent include alcohols and the like. For example, the alcohols are: non-aliphatic alcohols such as α-terpineol and the like; glycols such as butyl carbitol (diethylene glycol monobutyl ether), hexylene glycol (2-methyl-2,4-pentanediol), ethylene glycol-2-ethylhexyl ether, and the like; and so on. Alternatively, the organic solvent is preferably selected from N-methylpyrrolidone, dimethylformamide, dimethyl sulfoxide, cyclohexane, and the like in accordance with the affinity for carbons and the metal particles 20.

In the case of manufacturing an electrode by forming a dried material on a substrate from a paste-like conductive coating composition 100 by a squeegee method, all the previously-described alcohols can be used for the organic solvent. On the other hand, in the case of manufacturing an electrode by forming a dried material on a substrate from a paste-like conductive coating composition 100 by screen printing, the viscosity of the organic solvent needs to be increased, and a homogeneous coating film needs to be obtained. Therefore, as the organic solvent, α-terpineol, butyl carbitol, or the like is often used. Alternatively, in the case of performing spin coating, dip coating, spray coating, etc., a solvent with low viscosity such as aliphatic alcohol, ketones, and the like may be used, and ethanol, 2-propanol, methyl ethyl ketone, methyl isobutyl ketone, or the like may be also used. Also, a mixture of a solvent having a high boiling point and a solvent having a low boiling point may be used as the solvent. In that case, the ratio of the respective contained amounts is not particularly limited. However, as described previously, the amount of the solvent having a high boiling point is preferably 50 percent by mass or higher.

Between the graphite intercalation compounds 10 and the metal particles 20, metal carbides are present as additive substances. Therefore, the graphite intercalation compounds 10 are covalently or ionically bonded to the metal carbides, and the metal particles 20 are covalently or ionically bonded to the metal carbides.

The volume of the graphite intercalation compounds 10 in the conductive coating composition 100 is larger than the volume of the metal particles 20 in the conductive coating composition 100. For example, the volume of the graphite intercalation compounds 10 in the conductive coating composition 100 is 35 percent, and the volume of the metal particles 20 in the conductive coating composition 100 is 15 percent. The ratio is not limited to this.

As the metal particles 20, all sorts of metals can be used. For example, gold, silver, and copper are preferably used. The respective thermal expansion coefficients [10⁻⁶/K] are “14.3” (gold), “18.0” (silver), and “16.8” (copper), and the thermal expansion coefficient [10⁻⁶/K] of the graphite intercalation compounds 10 is “4.4”. On the other hand, the density [g/cm³] of the metal particles 20 is “19.3” (gold), “10.5” (silver), and “9.0” (copper), and the density [g/cm³] of the graphite intercalation compounds 10 is “2.2 to 2.4”. Under such a situation, when the volume of the metal particles 20 is larger than the volume of the graphite intercalation compounds 10, the thermal expansion rate becomes larger, and peeling from peripheral members such as a substrate and the like is thus more likely to happen. Further, in the previously-described case, since there are many soft materials, deformation is more likely to happen, becoming a cause for insufficient contact or peeling due to external forces or temperature changes. Also, in the previously-described case, since the density becomes higher, the weight is increased. Also, in the previously-described case, the cost is increased. In order to prevent at least one of these situations, the volume of the graphite intercalation compounds 10 is set to be larger than the volume of the metal particles 20, as described previously.

Also in a conductive material formed of graphite intercalation compounds 10 and metal particles 20, the volume of the graphite intercalation compounds 10 is larger than the volume of the metal particles 20 in the conductive material. For example, the volume of the graphite intercalation compounds 10 in the conductive material is 70 percent, and the volume of the metal particles 20 in the conductive material is 30 percent. The ratio is not limited to this.

In particular, the average particle size of the metal particles 20 is set to be smaller than 100 μm. The average particle size is measured by an optical microscope or a scanning electron microscope. When the average particle size, i.e., the size or diameter, of the metal particles 20 becomes smaller, the substantial melting point of the metal particles 20 becomes lowered. As a result, when the metal particles 20 are heated, the surface of the metal particles 20 becomes melted due to necking, and conductive paths are likely to be formed between the metal particles 20 and the graphite intercalation compounds 10. When the conductive paths are formed, the conductivity of the conductive coating composition 100 becomes increased. In general, when the average particle size of the metal particles 20 becomes 100 μm or higher, the necking phenomenon is less likely to happen.

An explanation will be now given regarding an example of a method for manufacturing the conductive coating composition 100 and the conductive material according to the present embodiment. (1) First, the graphite intercalation compounds 10 are produced. In order for this, a graphite material used as a raw material for the graphite intercalation compounds 10 is prepared. This graphite material has a layered structure formed by a laminate of graphene. Then, a chemical species serving as an intercalate is inserted between layers of the graphite material. The chemical species to be inserted is formed of the previously-described materials. In order to insert the chemical species into the graphite material, publicly-known technology, for example, a gas phase method or a liquid phase method is used. In the gas phase method, the vapor of the chemical species is brought into contact with graphite, which is a host, under high temperature. In the liquid phase method, graphite, which is the host, is immersed in a solution where the chemical species is dissolved in the organic solvent or a liquid obtained by melting the chemical species at high temperature.

(2) The conductive material, which is a mixture, is then produced by mixing the graphite intercalation compounds 10 and the metal particles 20. A ball mill, a three-roll mill, an extruder, a Banbury mixer, a V blender, a kneader, a ribbon mixer, a Henschel mixer, or the like is used at that time for uniform mixing. The production of the conductive material is not limited to these processes.

(3) A binder and a dissolving agent are added to a container having an agitator and a heating device, and a binder solution is produced while carrying out agitation and heating. (4) By adding the conductive material in the binder solution and then carrying out mixing and kneading, the conductive material is dispersed in the binder solution so as to manufacture the conductive coating composition 100. Further, by burning the conductive coating composition 100, a conductive wire may be manufactured.

An explanation will now be given regarding an exemplary embodiment according to the present embodiment.

### First Exemplary Embodiment

First, 2 g of iron chloride (99.9%) was dissolved in 125 ml of ethanol (99.5%, special grade chemical), and 9.61 ml of pentaethylene hexamine (ethyleneamine mixture) was then added therein so as to form a Fe-N complex. As graphite, 4.0 g of natural graphite manufactured by Ito Graphite Co., Ltd. having an average particle size of 10 μm was added to this solution and then dispersed by an ultrasonic homogenizer. After the dispersion, the ethanol was immediately removed by a rotary evaporator, and solids were taken out.

The solids were packed in a stoppered silica tube (a diameter of 16 mm and a length of 500 mm) having a shape of a test tube and heated under a flow of a gas mixture of 1 percent O₂ and 99 percent N₂ for 90 seconds under 900 degrees Celsius. After cooling, graphite carrying iron was recovered. The graphite carries iron through nitrogen atoms. By washing the graphite carrying iron with ultrapure water, impurities remaining on the surface thereof were removed. Into a glass ampule, 0.06 g of this graphite carrying iron, 0.26 g of potassium chloride, and 0.6 g of anhydrous copper (II) chloride were vacuum-encapsulated, and the ampule was processed with heat for ten hours at 400 degrees Celsius. After natural cooling, the graphite was taken out from the ampule, and, by removing potassium chloride and copper (II) chloride attached on the surface thereof by washing with water, graphite intercalation compounds 10 were obtained.

As the metal particles 20, silver powder manufactured by Sigma-Aldrich Co. LLC having an average particle size of 2 μm was prepared, and the silver powder manufactured by Sigma-Aldrich Co. LLC and the graphite intercalation compounds 10 were mixed in a volume ratio of 33:64 so as to obtain a conductive material, which was a composite material of the graphite intercalation compounds 10 and the metal particles 20. Further, the conductive material was put in an amount of 0.1 g in a cylindrical mold having a diameter of 10 mm, and a pressure of 200 MPa was applied so as to obtain a cylindrical-shaped green compact of the conductive material.

### Second Exemplary Embodiment

Instead of the graphite carrying iron in the first exemplary embodiment, natural graphite manufactured by Ito Graphite Co., Ltd., having an average particle size of 10 μm was used. The same as described in the first exemplary embodiment applies to the rest.

### Comparative Example

Instead of the graphite intercalation compounds 10 in the first exemplary embodiment, natural graphite manufactured by Ito Graphite Co., Ltd., having an average particle size of 10 μm was used. The same as described in the first exemplary embodiment applies to the rest.

Volume resistivity of a green compact of a conductive material in each of the first exemplary embodiment, the second exemplary embodiment, and the comparative example is measured by a four-point probe method. As a result, the volume resistivity in the first exemplary embodiment is 18 [μΩcm], the volume resistivity in the second exemplary embodiment is 45 [μΩcm], and the volume resistivity in the comparative example is 120 [μΩcm]. According to this, compared to the comparative example, volume resistivity is lower in the first and second exemplary embodiments.

According to the embodiment of the present invention, since the volume of the graphite intercalation compounds 10 is larger than the volume of the metal particles 20 in the conductive coating composition 100, the graphite intercalation compounds 10 are connected to one another by the metal particles 20. Further, since the graphite intercalation compounds 10 are connected to one another by the metal particles 20, the conductivity can be improved. Also, since the graphite intercalation compounds 10 are used, an increase in the unit price can be prevented. Further, since metal chlorides are intercalated in the graphite intercalation compounds 10, the conductivity can be improved. Also, since the average particle size of the metal particles 20 is smaller than 100 μm, conductive paths can be more likely to be formed. Further, since the conductive paths are more likely to be formed, the conductivity can be improved.

Also, since the graphite intercalation compounds 10 and the metal particles 20 are covalently or ionically bonded to each other via metal carbides, the conductivity can be improved. Further, since the volume of the graphite intercalation compounds 10 is larger than the volume of the metal particles 20 in the conductive material, the graphite intercalation compounds 10 are connected to one another by the metal particles 20. Also, since low cost and highly conductive graphite intercalation compounds 10 are used for a wiring material for which an expensive metal material is conventionally used, the cost can be lowered while keeping high conduction characteristics. Further, since the graphite intercalation compounds 10 are bonded to one another using the small amount of metal particles 20, high conductivity that cannot be achieved by conventional carbon-based wires can be achieved. Also, since there exist nitrogen atoms between the graphite intercalation compounds 10 and the metal particles 20, iron can be easily carried by graphite, and the metal particles 20 can be easily bonded to the graphite intercalation compounds 10.

A brief description of the present embodiment is as shown in the following. A conductive coating composition 100 according to one embodiment of the present invention includes graphite intercalation compounds 10, metal particles 20, a binder, and a dissolving agent, and the volume of the graphite intercalation compounds 10 in the conductive coating composition 100 is larger than the volume of the metal particles 20 in the conductive coating composition 100.

Metal chlorides may be intercalated in the graphite intercalation compounds 10.

The average particle size of the metal particles 20 is smaller than 100 μm.

The graphite intercalation compounds 10 and the metal particles 20 may be chemically bonded.

Nitrogen atoms may exist between the graphite intercalation compounds 10 and the metal particles 20.

Metal carbides may exist between the graphite intercalation compounds 10 and the metal particles 20.

The graphite intercalation compounds 10 may be covalently or ionically bonded to the metal carbides, and the metal particles 20 may be covalently or ionically bonded to the metal carbides.

Another embodiment of the present invention relates to a conductive material. The conductive material includes graphite intercalation compounds 10 and metal particles 20, and the volume of the graphite intercalation compounds 10 in the conductive material is larger than the volume of the metal particles 20 in the conductive material.

Yet another embodiment of the present invention relates to a method for manufacturing a conductive coating composition 100. This is a method for manufacturing the conductive coating composition 100, comprising: producing a conductive material by mixing graphite intercalation compounds 10 and metal particles 20; producing a binder solution while agitating and heating a binder and a dissolving agent; and adding the conductive material in the binder solution, wherein the volume of the graphite intercalation compounds 10 in the conductive coating composition 100 is larger than the volume of the metal particles 20 in the conductive coating composition 100.

Yet another embodiment of the present invention relates to a method for manufacturing a conductive material. This is a method for manufacturing a conductive material in which graphite intercalation compounds 10 and metal particles 20 are mixed, and the volume of the graphite intercalation compounds 10 in the conductive material is larger than the volume of the metal particles 20 in the conductive material.

Described above is an explanation of the present invention based on the embodiments. These embodiments are intended to be illustrative only, and it will be obvious to those skilled in the art that various modifications to combinations of constituting elements could be developed and that such modifications are also within the scope of the present invention.

### Description of the Reference Numerals

10 graphite intercalation compound, 20 metal particle, 100 conductive coating composition

### INDUSTRIAL APPLICABILITY

According to the present invention, conductivity can be improved while preventing an increase in unit price.

1. A conductive coating composition comprising: graphite intercalation compounds; metal particles; a binder; and a dissolving agent,
wherein the volume of the graphite intercalation compounds in the conductive coating composition is larger than the volume of the metal particles in the conductive coating composition.

2. The conductive coating composition according to claim 1, wherein metal chlorides are intercalated in the graphite intercalation compounds.

3. The conductive coating composition according to claim 1, wherein the average particle size of the metal particles is smaller than 100 μm.

4. The conductive coating composition according claim 1, wherein the graphite intercalation compounds and the metal particles are chemically bonded.

5. The conductive coating composition according to claim 4, wherein nitrogen atoms exist between the graphite intercalation compounds and the metal particles.

6. The conductive coating composition according to claim 1, wherein metal carbides exist between the graphite intercalation compounds and the metal particles.

7. The conductive coating composition according to claim 6, wherein the graphite intercalation compounds are covalently or ionically bonded to the metal carbides, and the metal particles are covalently or ionically bonded to the metal carbides.

8. A conductive material comprising: graphite intercalation compounds; and metal particles,
wherein the volume of the graphite intercalation compounds in the conductive material is larger than the volume of the metal particles in the conductive material.

9. A method for manufacturing a conductive coating composition, comprising:
producing a conductive material by mixing graphite intercalation compounds and metal particles;
producing a binder solution while agitating and heating a binder and a dissolving agent; and
adding the conductive material in the binder solution,
wherein the volume of the graphite intercalation compounds in the conductive coating composition is larger than the volume of the metal particles in the conductive coating composition.

10. A method for manufacturing a conductive material in which graphite intercalation compounds and metal particles are mixed,
wherein the volume of the graphite intercalation compounds in the conductive material is larger than the volume of the metal particles in the conductive material.
